(19) United States
(12) Patent Application Publication
(10) Pub. No.: US 2003/0190063 A1
(43) Pub. Date: Oct. 9, 2003

(54) Method and system for performing coronary artery calcification scoring

(76) Inventors: Kishore C. Acharya, Brookfield, WI (US); Priya Gopinath, Waukesha, WI (US); Litao Yan, Waukesha, WI (US)

Correspondence Address: CANTOR COLBURN, LLP, 55 GRIFFIN ROAD SOUTH, BLOOMFIELD, CT, 06002

(21) Appl. No.: 09/683,991

(22) Filed: Mar. 8, 2002

(51) Int. Cl. G06K 9/40

(52) U.S. Cl. 382/128; 382/262

(57) ABSTRACT

A method and system for performing coronary artery calcification scoring using an imaging system including obtaining image data; examining the image data so as to identify a plurality of discrete pixel elements, wherein each of the pixel elements includes a pixel value; dividing the pixel elements into a scorable region so as to create a plurality of scorable pixel elements; processing the scorable pixel elements so as to identify a center scorable pixel element and determine a median pixel value; and replacing the pixel value for the center scorable pixel element with the median pixel value. Also claimed is a medium encoded with a machine-readable computer program code for performing coronary artery calcification scoring, the medium including instructions for causing controller to implement the aforementioned method.

### BACKGROUND OF INVENTION

This invention relates generally to a method and system for performing coronary artery calcification scoring and more particularly to a method and system for performing coronary artery calcification scoring using an imaging system.

In at least one known computed tomography (CT) imaging system configuration, an x-ray source projects a fan-shaped beam which is collimated to lie within an X-Y plane of a Cartesian coordinate system, wherein the X-Y plane is generally referred to as an “imaging plane”. An array of radiation detectors, wherein each radiation detector includes a detector element, are within the CT system so as to received this fan-shaped beam. An object, such as a patient, is disposed within the imaging plane so as to be subjected to the x-ray beam wherein the x-ray beam passes through the object. As the x-ray beam passes through the object being imaged, the x-ray beam becomes attenuated before impinging upon the array of radiation detectors. The intensity of the attenuated beam radiation received at the detector array is responsive to the attenuation of the x-ray beam by the object, wherein each detector element produces a separate electrical signal responsive to the beam attenuation at the detector element location. These electrical signals are referred to as x-ray attenuation measurements.

In addition, the x-ray source and the detector array may be rotated, with a gantry within the imaging plane, around the object to be imaged so that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles during one revolution of the x-ray source and the detector array. In an axial scan, the projection data is processed so as to construct an image that corresponds to a two-dimensional slice taken through the object.

One method for reconstructing an image from a set of projection data is referred to as the “filtered back-projection technique”. This process converts the attenuation measurements from a scan into discrete integers, ranging from −2047 to +2047, called “CT numbers” or “Hounsfield Units” (HU). These HU's are used to control the brightness of a corresponding pixel on a cathode ray tube or a computer screen display in a manner responsive to the attenuation measurements. For example, an attenuation measurement for air may convert into an integer value of −2047 HU's (corresponding to a dark pixel) and an attenuation measurement for very dense bone matter may convert into an integer value of +2000 (corresponding to a bright pixel), whereas an attenuation measurement for water may convert into an integer value of OHU's (corresponding to a gray pixel). This integer conversion, or “scoring” allows a physician or a technician to determine the density of matter based on the intensity of the computer display.

However, because the objects to be imaged may vary in size and mass, undesirable signal anomalies, such as noise, may be present in the constructed image. For example, in order to perform a coronary artery scan of a patient, the incident x-ray beam needs to have enough power to penetrate the patients' body, become attenuated by different masses within the patients' body and have still have enough energy remaining so as to allow the detector array to receive the x-ray beam and generate accurate signals responsive to the beam attenuation. If the patient is of average size, an accurate image may be constructed using a standard dose of x-ray energy. However, as the patient increases in size and mass, the x-ray energy needed to construct an accurate image increases as well, thus requiring larger size patients to be exposed to larger amounts of x-ray energy. If the beam energy is not increased for larger patients' a large amount of noise may be present in the images and in some situations the images cannot be used for calcium scoring. Therefore, the x-ray beam intensity must be increased to compensate for the larger body mass, which is undesirable because of the health consequences of being exposed to large amounts of x-ray radiation. This is also undesirable because of the increased energy costs to produce larger x-ray beam intensities.

Therefore, there is a need for a low-cost method for reliably performing calcification scoring wherein the method is easily and inexpensively implemented and wherein the method would expose patients' to lower doses of x-ray radiation then is currently occurring. The above discussed and other features and advantages of the present invention will be appreciated and understood by those skilled in the art from the following detailed description and drawings.

### SUMMARY OF INVENTION

The above discussed and other drawbacks and deficiencies are overcome or alleviated by a method for performing coronary artery calcification scoring using an imaging system comprising: obtaining image data; examining the image data so as to identify a plurality of discrete pixel elements, wherein each of the pixel elements includes a pixel value; dividing the pixel elements into a scorable region so as to create a plurality of scorable pixel elements; processing the scorable pixel elements so as to identify a center scorable pixel element and determine a median pixel value; and replacing the pixel value for the center scorable pixel element with the median pixel value.

In an alternative embodiment a system for performing coronary artery calcification scoring comprising: a gantry having an x-ray source and a radiation detector array, wherein the gantry defines a patient cavity and wherein said x-ray source and the radiation detector array are rotatingly associated with the gantry so as to be separated by the patient cavity; a patient support structure movingly associated with the gantry so as to allow communication with the patient cavity; and a processing device having an enhancing filter, wherein the enhancing filter, obtains image data; examines the image data so as to identify a plurality of discrete pixel elements, wherein each of the pixel elements includes a pixel value; divides the pixel elements into a scorable region so as to create a plurality of scorable pixel elements; processes the scorable pixel elements so as to identify a center scorable pixel element and determine a median pixel value; and replaces the pixel value for the center scorable pixel element with the median pixel value.

In another alternative embodiment, a medium encoded with a machine-readable computer program code for performing coronary artery calcification scoring, the medium including instructions for causing controller to implement the aforementioned method.

The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several Figures:

FIG. 1 is a perspective view of a CT imaging system and a patient disposed for imaging in accordance with an exemplary embodiment;

FIG. 2 is a block schematic diagram of a CT imaging system in accordance with an exemplary embodiment;

FIG. 3 is a flow diagram describing a method for performing coronary artery calcification scoring in accordance with an exemplary embodiment;

FIG. 4 illustrates an output device that includes a display screen having a plurality of discrete pixel element in accordance with an exemplary embodiment;

FIG. 5 illustrates a 3×3 matrix having scorable pixel elements with individual pixel values in accordance with an exemplary embodiment;

FIG. 6 illustrates a 3×3 matrix having scorable pixel elements with the center scorable pixel element after pixel value replacement in accordance with an exemplary embodiment;

FIG. 7 illustrates a 3×3 matrix wherein the center scorable pixel element is undergoing pixel value replacement in accordance with an exemplary embodiment; and

FIG. 8 illustrates a 3×3 matrix wherein the center scorable pixel element is undergoing pixel value replacement in accordance with an alternative embodiment.

### DETAILED DESCRIPTION

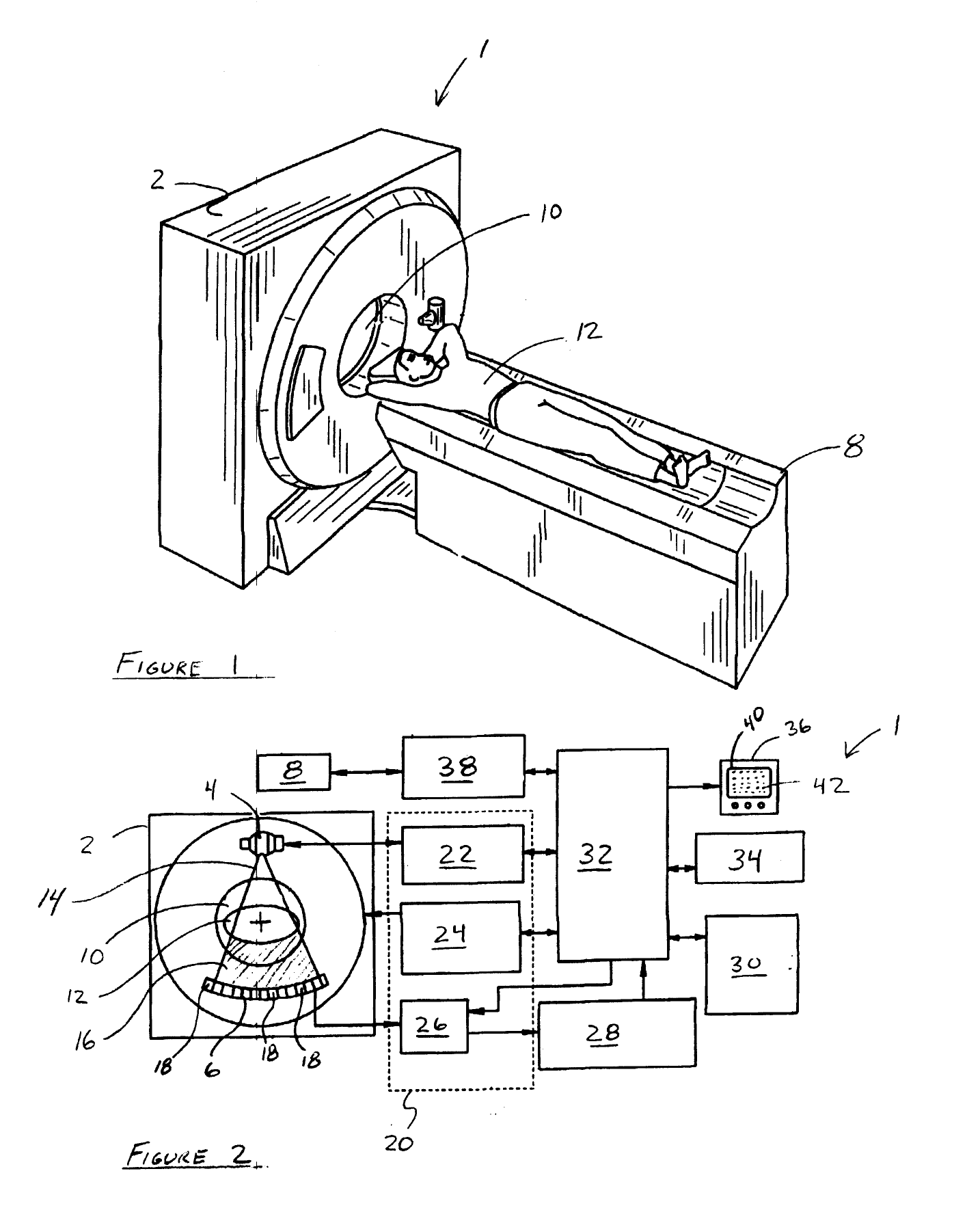

Referring to FIG. 1 and FIG. 2 a representative CT imaging system 1 is shown and preferably includes a gantry 2 having an x-ray source 4, a radiation detector array 6, a patient support structure 8 and a patient cavity 10, wherein x-ray source 4 and radiation detector array 6 are opposingly disposed so as to be separated by patient cavity 10. A patient 12 is preferably dispose upon patient support structure 8 which is then disposed within patient cavity 10. X-ray source 4 projects an x-ray beam 14 toward radiation detector array 6 so as to pass through patient 12. X-ray beam 6 is preferably collimated by a collimate (not shown) so as to lie within an X-Y plane of a Cartesian coordinate system referred to as an “imaging plane”. After passing through and becoming attenuated by patient 12, attenuated x-ray beam 16 is preferably received by radiation detector array 6. Radiation detector array 6 preferably includes a plurality of detector elements 18 wherein each of said detector elements 18 receives attenuated x-ray beam 16 and produces an electrical signal responsive to the intensity of attenuated x-ray beam 16.

In addition, x-ray source 4 and radiation detector array 6 are preferably rotatingly disposed relative to gantry 2 and patient support structure 8, so as to allow x-ray source 4 and radiation detector array 6 to rotate around patient support structure 8 when patient support structure 8 is disposed within patient cavity 10. X-ray projection data is obtained by rotating x-ray source 4 and radiation detector array 6 around patient 10 during a scan. X-ray source 4 and radiation detector array 6 are preferably communicated with a control mechanism 20 associated with CT imaging system 1. Control mechanism 20 preferably controls the rotation and operation of x-ray source 4 and radiation detector array 6.

Control mechanism 20 preferably includes an x-ray controller 22 communicated with x-ray source 4, a gantry motor controller 24, and a data acquisition system (DAS) 26 communicated with radiation detector array 6, wherein x-ray controller 22 provides power and timing signals to x-ray source 4, gantry motor controller 24 controls the rotational speed and angular position of x-ray source 4 and radiation detector array 6 and DAS 26 receives the electrical signal data produced by detector elements 18 and converts this data into digital signals for subsequent processing. CT imaging system 1 also preferably includes an image reconstruction device 28, a data storage device 30 and a processing device 32, wherein processing device 32 is communicated with image reconstruction device 28, gantry motor controller 24, x-ray controller 22, data storage device 30, an input device 34 and an output device 36. Moreover, CT imaging system 1 also preferably includes a table controller 38 communicated with processing device 32 and patient support structure 8, so as to control the position of patient support structure 8 relative to patient cavity 10.

In accordance with an exemplary embodiment, patient 12 is preferably disposed on patient support structure 8, which is then positioned by an operator via processing device 32 so as to be disposed within patient cavity 10. Gantry motor controller 24 is operated via processing device 32 so as to cause x-ray source 4 and radiation detector array 6 to rotate relative to patient 12. X-ray controller 22 is operated via processing device 32 so as to cause x-ray source 4 to emit and project a collimated x-ray beam 14 toward radiation detector array 6 and hence toward patient 12. X-ray beam 14 passes through patient 12 so as to create an attenuated x-ray beam 16, which is received by radiation detector array 6.

Detector elements 18 receive attenuated x-ray beam 16, produces electrical signal data responsive to the intensity of attenuated x-ray beam 16 and communicates this electrical signal data to DAS 26. DAS 26 then converts this electrical signal data to digital signals and communicates both the digital signals and the electrical signal data to image reconstruction device 28, which performs high-speed image reconstruction. This information is then communicated to processing device 32, which stores the image in data storage device 30 and displays the digital signal as an image via output device 36.

In accordance with an exemplary embodiment, output device 36 preferably includes a display screen 40 having a plurality of discrete pixel elements 42. An operator visually examines the image via output device 36 and determines if the image contains an unacceptable amount of signal noise. If the amount of signal noise is unacceptable, the operator filters out the unwanted noise by activating an enhancing filter 100 via input device 34.

Referring to the figures, a flow diagram describing a method for performing coronary artery calcification scoring is shown and discussed. In accordance with an exemplary embodiment, image data is obtained as shown in step 102. In accordance with an exemplary embodiment, image data is preferably obtained using CT imaging system 1 and displayed to an operator as an image via output device 36 as described hereinabove. The operator then examines the image and if it is determined that an unacceptable amount of signal noise is present, the operator may apply enhancing filter 100 to the image data via input device 34.

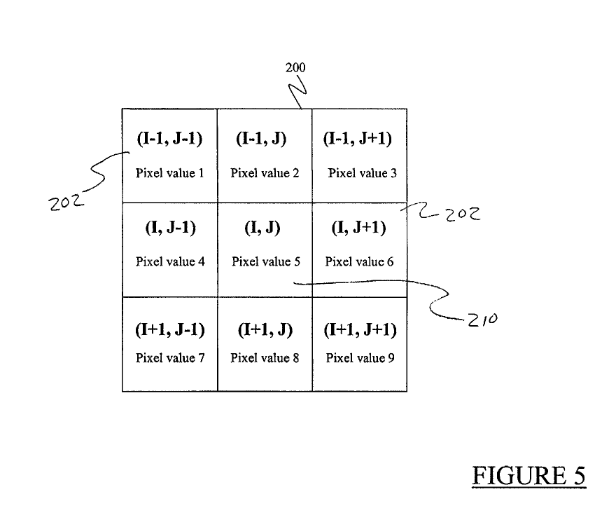

Once enhancing filter 100 is activated, processing device 32 examines the image data so as to identify a plurality of discrete pixel elements 42 as shown in step 104. The plurality of discrete pixel elements 42 are then preferably divided into a plurality of 3×3 matrices 200, as shown in step 106. In accordance with an exemplary embodiment, each 3×3 matrix 200 preferably includes nine scorable pixel elements 202 divided into three rows (I−1, I, I+1) and three columns (J−1, J, J+1), as shown in FIG. 5. In accordance with an exemplary embodiment, each of the scorable pixel elements 202 includes a pixel value responsive to the intensity of attenuated x-ray beam 16 received by detector elements 18. Scorable pixel elements 202 are then processed so as to identify a median pixel value PV5, as shown in step 108. This is preferably done by arranging scorable pixel elements 202 in ascending or descending order base on the pixel value of each scorable pixel element 202. The median pixel element 204 is then determined by identifying the scorable pixel element 202 that has the fifth largest pixel value. The scorable pixel element 202 having the fifth largest pixel value is then identified as the median pixel element 204.

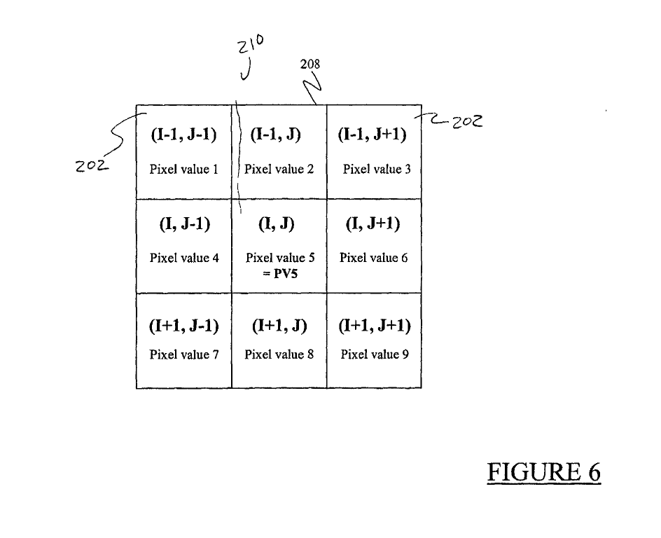

In accordance with an exemplary embodiment, median pixel element 204 is then examined so as to identify median pixel value PV5. This is preferably accomplished by determining the pixel value of median pixel element 204 and assigning this pixel value to median pixel value PV5. Once median pixel value PV5 is identified the pixel value for a center scorable pixel element 210 disposed in position (I, J) of 3×3 matrix 200 is replaced by median pixel value PV5 so as to create a filtered pixel matrix 208, as shown in step 110. Once this is complete, each of the scorable pixel elements 202 of 3×3 matrix 200 has its original pixel value and the center scorable pixel element 210 disposed in position (l, J) of 3×3 matrix 200 has a pixel value equal to median pixel value PV5, as shown in FIG. 6. The image data is then stored as a new filtered image so as to reflect this pixel value replacement and this new image information is then stored in data storage device 30.

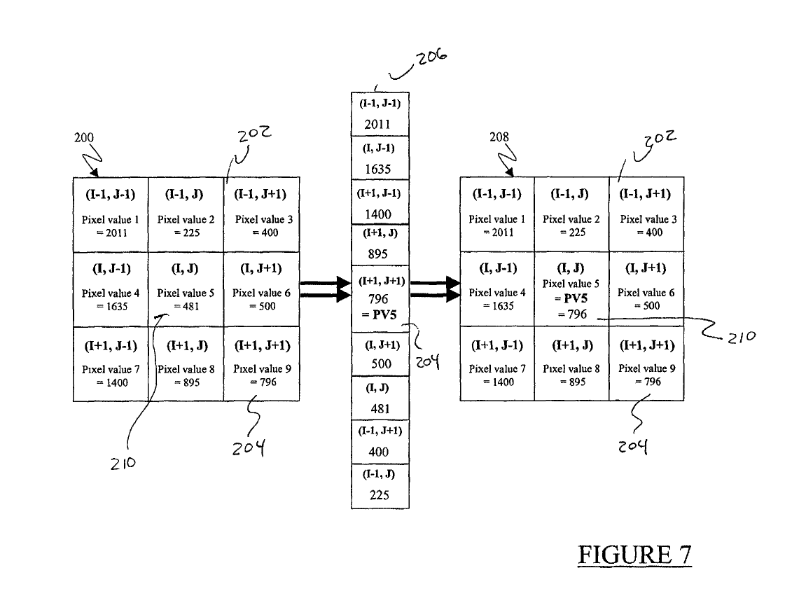

For example, referring to FIG. 7 a 3×3 matrix 200 is shown having scorable pixel elements 202 wherein each scorable pixel element 202 includes an individual pixel value identified as pixel value 1 through pixel value 9. In this example, pixel value 1 through pixel value 9 are assigned random pixel values for demonstration purposes only. In accordance with an exemplary embodiment, pixel value 1 through pixel value 9 are in fact responsive to obtained image data. Scorable pixel elements 202 are then processed so as to identify a median pixel value PV5, as shown in step 108. This is preferably done by arranging scorable pixel elements 202 in ascending or descending order 206. The median pixel element 204 is then determined by identifying the scorable pixel element 202 having the fifth largest pixel value. This scorable pixel element 202 is then selected as the median pixel element 204. The pixel value for median pixel element 204 is then selected as the median pixel value PV5, in this case PV5 equals 796 HU. The pixel value for the center scorable pixel element 210 disposed in position (I, J) of 3×3 matrix 200 is then replaced by PV5 so as to have a value of 796 HU. The pixel values of the remaining scorable pixel elements 202 in 3×3 matrix 200 retain their original pixel value, so as to create a filtered pixel matrix 208.

It should be understood that the exemplary embodiment described hereinabove may be applied using any N×N matrix, where N is an odd integer, such as 7, 9, 11. In accordance with an exemplary embodiment median pixel element 204 has the [((N*N)/2)+0.5] largest pixel value, wherein N is the number of rows and the number of columns.

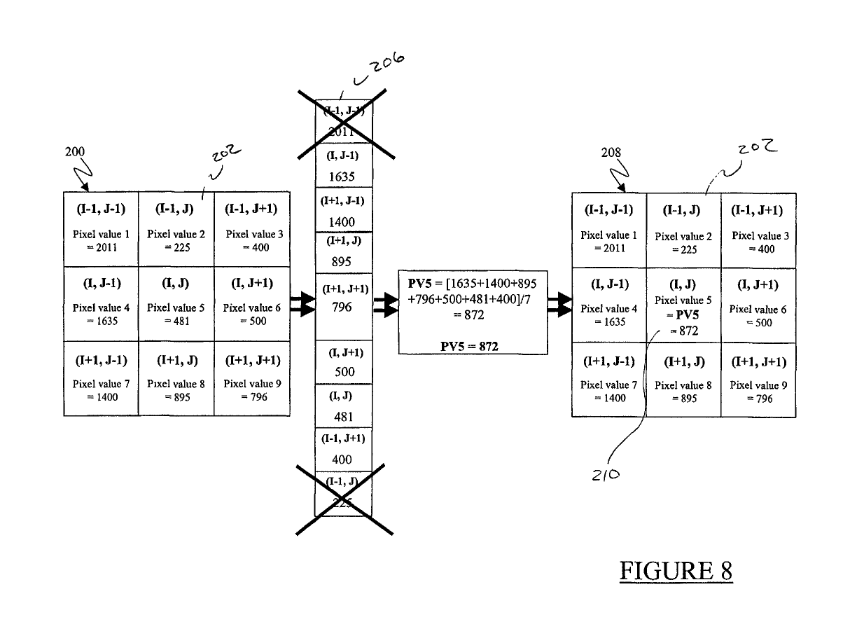

Referring to FIG. 8 an alternative embodiment is discussed. In accordance with an alternative embodiment, scorable pixel elements 202 are processed so as to identify a median pixel value PV5, as shown in step 108. This is preferably done by arranging scorable pixel elements 202 in ascending or descending order base on the pixel value of each scorable pixel element 202. The median pixel element 204 is then determined by discarding the scorable pixel elements 202 having the largest and the smallest pixel values. The pixel values of the remaining scorable pixel elements 202 are then added together. This sum is then divided by the number of remaining scorable pixel elements 202 so as to obtain an average pixel value. This average pixel value is then selected as the median pixel value PV5. In this case, PV5 is equal to 872 HU.

Once median pixel value PV5 is identified the pixel value for the center scorable pixel element 210 disposed in position (I, J) of 3×3 matrix 200 is then replaced by PV5 so as to have a value of 872 HU. The pixel values of the remaining scorable pixel elements 202 in 3×3 matrix 200 retain their original pixel value, so as to create a filtered pixel matrix 208, as shown in step 110. Once this is complete, each of the scorable pixel elements 202 of 3×3 matrix 200 has its original pixel value and center scorable pixel element 210 has a pixel value equal to median pixel value PV5. The image data is then stored as a new filtered image so as to reflect this pixel value replacement and this new image information is then stored in data storage device 30. It should be understood that the alternative embodiment described hereinabove may be applied using any N×N matrix, where N is an odd integer, such as 7, 9, 11.

This invention advantageously allows for objects, such as a patient 12, to be scanned using lower dose scans, thus reducing the energy required to generate larger radiation doses. In addition, potential health problems may be avoided by reducing the patients' exposure to x-ray radiation to more acceptable levels.

In accordance with an exemplary embodiment, enhancing filter 100 may be applied to image data obtained by any imaging system suitable to the desired end purpose, such as a magnetic resonance imaging (MRI) system.

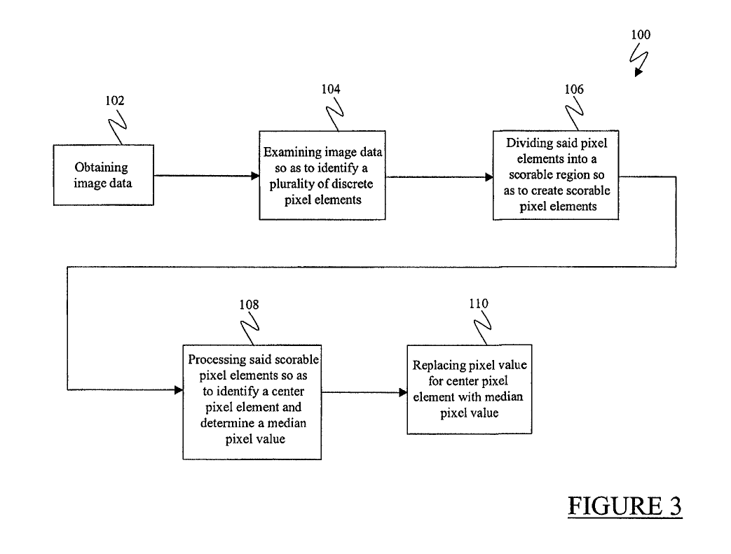

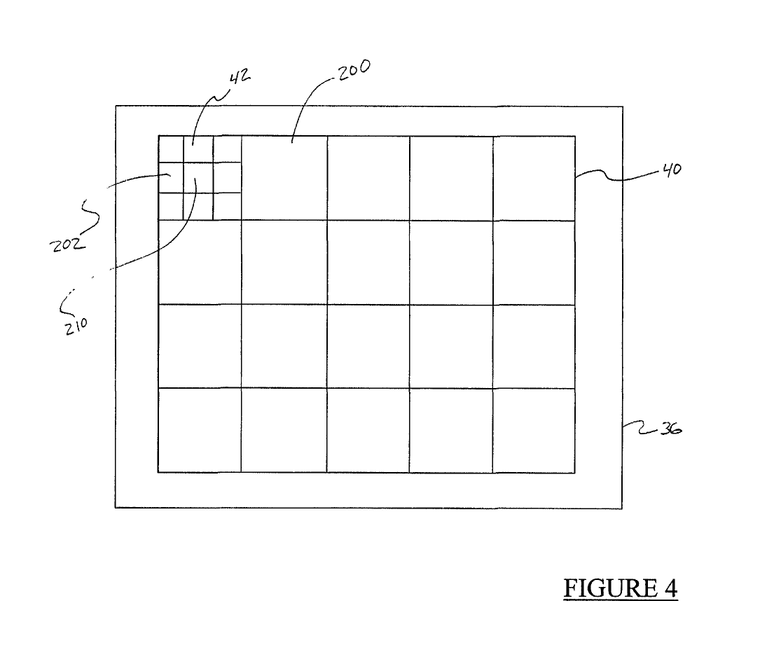

In accordance with an exemplary embodiment, processing of FIG. 3 may be implemented through processing device 32 operating in response to a computer program. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces. It is also considered within the scope of the invention that the processing of FIG. 3 may be implemented by a controller located remotely from processing device 32.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The present invention can also be embodied in the form of computer program code, for example, whether stored in a storage medium, loaded into and/or executed by a computer, or transmitted over some transmission medium, such as electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for performing coronary artery calcification scoring using an imaging system comprising:obtaining image data; examining said image data so as to identify a plurality of discrete pixel elements, wherein each of said pixel elements includes a pixel value; dividing said pixel elements into a scorable region so as to create a plurality of scorable pixel elements; processing said scorable pixel elements so as to identify a center scorable pixel element and determine a median pixel value; and replacing said pixel value for said center scorable pixel element with said median pixel value.

2. The method of claim 1, wherein said obtaining image data includes obtaining image data using a computed tomography imaging system.

3. The method of claim 1, wherein said pixel value is a number between about −2047 and about +2047.

4. The method of claim 1, wherein said dividing includes dividing said pixel elements into a 3×3 matrix of said scorable pixel elements having 3 rows and 3 columns.

5. The method of claim 1, wherein said dividing includes dividing said pixel elements into an N×N matrix of said scorable pixel elements having N rows and N columns, wherein N is an odd integer.

6. The method of claim 5, wherein said processing includes examining said scorable region so as to identify a median pixel element.

7. The method of claim 6, wherein said median pixel element has the [((N*N)/2)+0.5] largest pixel value, wherein N is the number of said rows and said columns.

8. The method of claim 6, wherein said processing further includes assigning said pixel value of said median pixel element as said median pixel value.

9. The method of claim 1, wherein said processing includes arranging said scorable pixel elements in ascending order in a manner responsive to said pixel value.

10. The method of claim 1, wherein said processing further includes examining said scorable pixel elements so as to identify the highest pixel value and the lowest pixel value.

11. The method of claim 10, wherein said processing further includes discarding said highest pixel value and said lowest pixel value so as to create remaining pixel elements.

12. The method of claim 11, wherein said processing further includes summing said pixel values of said remaining pixel elements so as to create a pixel value sum and dividing said pixel value sum by the number of remaining pixel elements so as to create said median pixel value.

13. The method of claim 1, wherein said replacing includes equating said pixel value for said center scorable pixel element with said median pixel value.

14. A medium encoded with a machine-readable computer program code for performing coronary artery calcification scoring, said medium including instructions for causing controller to implement a method comprising:
obtaining image data; examining said image data so as to identify a plurality of discrete pixel elements, wherein each of said pixel elements includes a pixel value; dividing said pixel elements into a scorable region so as to create a plurality of scorable pixel elements; processing said scorable pixel elements so as to identify a center scorable pixel element and determine a median pixel value; and replacing said pixel value for said center scorable pixel element with said median pixel value.

15. The method of claim 14, wherein said dividing includes dividing said pixel elements into a 3×3 matrix of said scorable pixel elements having 3 rows and 3 columns.

16. The method of claim 14, wherein said dividing includes dividing said pixel elements into an N×N matrix of said scorable pixel elements having N rows and N columns, wherein N is an odd integer.

17. The method of claim 16, wherein said processing includes examining said scorable region so as to identify a median pixel element.

18. The method of claim 17, wherein said processing further includes assigning said pixel value of said median pixel element as said median pixel value.

19. The method of claim 14, wherein said processing includes arranging said scorable pixel elements in ascending order in a manner responsive to said pixel value.

20. The method of claim 14, wherein said processing further includes examining said scorable pixel elements so as to identify the highest pixel value and the lowest pixel value.

21. The method of claim 20, wherein said processing further includes discarding said highest pixel value and said lowest pixel value so as to create remaining pixel elements.

22. The method of claim 21, wherein said processing further includes summing said pixel values of said remaining pixel elements so as to create a pixel value sum and dividing said pixel value sum by the number of remaining pixel elements so as to create said median pixel value.

23. The method of claim 14, wherein said replacing includes equating said pixel value for said center scorable pixel element with said median pixel value.

24. A method for performing coronary artery calcification scoring comprising:
obtaining an imaging system and an object to be scanned;
operating said imaging system so as to create image data;
displaying said image data on an output device;
examining said image data so as to determine if said image data should be filtered; and
processing said image data using an enhancing filter wherein said enhancing filter,
divides said pixel elements into a scorable region having scorable pixel elements, wherein each of said scorable pixel elements includes a pixel value;
processes said scorable pixel elements so as to identify a center scorable pixel element and determine a median pixel value; and
replaces said pixel value for said center scorable pixel element with said median pixel value.

25. A system for performing coronary artery calcification scoring comprising:
a gantry having an x-ray source and a radiation detector array, wherein said gantry defines a patient cavity and wherein said x-ray source and said radiation detector array are rotatingly associated with said gantry so as to be separated by said patient cavity;
a patient support structure movingly associated with said gantry so as to allow communication with said patient cavity; and
a processing device having an enhancing filter, wherein said enhancing filter, obtains image data;
examines said image data so as to identify a plurality of discrete pixel elements, wherein each of said pixel elements includes a pixel value;
divides said pixel elements into a scorable region so as to create a plurality of scorable pixel elements;
processes said scorable pixel elements so as to identify a center scorable pixel element and determine a median pixel value; and
replaces said pixel value for said center scorable pixel element with said median pixel value.

26. A system according to claim 25, wherein said processing device includes an input device and an output device.

27. A system according to claim 25, wherein said enhancing filter is activated via said input device.

28. A system for performing coronary artery calcification scoring comprising:
an imaging system;
a patient support structure movingly associated with said imaging system so as to allow communication between said imaging system and a patient, wherein
said imaging system generates image data responsive to said patient; and
a processing device having an enhancing filter, wherein said enhancing filter, obtains said image data;
examines said image data so as to identify a plurality of discrete pixel elements, wherein each of said pixel elements includes a pixel value;
divides said pixel elements into a scorable region so as to create a plurality of scorable pixel elements;
processes said scorable pixel elements so as to identify a center scorable pixel element and determine a median pixel value; and
replaces said pixel value for said center scorable pixel element with said median pixel value.
